(19) United States
(12) Patent Application Publication
(10) Pub. No.: US 2008/0133067 A1
(43) Pub. Date: Jun. 5, 2008

(54) VEHICLE MONITORING SYSTEM

(76) Inventor: Rod DeMay, Woodland Hills, CA (US)

Correspondence Address: Dianoosh Salehi;SNELL & WILMER L.L.P., 600 Anton Boulevard, Suite 1400, Costa Mesa, CA, 92626-7689, US

(21) Appl. No.: 11/948,830

(22) Filed: Nov. 30, 2007

Related U.S. Application Data
(60) Provisional application No. 60/861,767, filed on Nov. 30, 2006.
(60) Provisional application No. 60/872,793, filed on Dec. 5, 2006.

(51) Int. Cl. G01M 17/00; G01S 5/00

(52) U.S. Cl. 701/1; 701/213

(57) ABSTRACT

A vehicle monitoring system including a computer with a main database, and a vehicle monitoring module, including a first processor and a local database. The computer being configured to execute a software application or the equivalent configured to accept a criteria from at least one input; analyze the criteria to determine specific information required from the main database for retrieving a vehicle parameter; extract the specific information from the main database; and convey the specific information to the first processor. The first processor is configured to receive the specific information regarding the vehicle parameter taken from the main database and convey and store the specific information regarding the vehicle parameter to the local database. The first processor is also configured to communicate with a vehicle computer network to read certain data from the vehicle computer network related to the vehicle parameter.

This application claims the benefit and priority of Provisional Patent Application Ser. No. 60/861,767, filed Nov. 30, 2006, and Provisional Patent Application Ser. No. 60/872,793, filed Dec. 5, 2006, both of which are herein incorporated in their entirety by reference for all purposes.

### BACKGROUND

1. Field

The invention relates generally to the field of electronic monitoring devices, and more specifically to a vehicle monitoring module having improved processing capabilities.

2. Related Art

Modern vehicles contain on-board computers that provide a mechanism to receive/send key operating information via the On-Board Diagnostics version II (OBD II) communication channel. The OBD II is a standard defining the mechanical, electrical, and data transport to facilitate information exchange between vehicle Electronic Control Modules (ECMs) as well as external modules, such as scan tools, which are commonly used for diagnosing and setting vehicle parameters.

External modules, such as scan tools, are known in the art and are testing devices that interface with vehicle diagnostic systems to access, display, and/or print vehicle diagnostic information. The OBD II scan tools are one commonly known type of scan tool and are governed by a number of standards. The current OBD II standard defines five signaling protocols (SAE J1850 PWM, SAE J1850 VPW, ISO 9141-2, ISO 14230 KWP2000, and ISO 15765 CAN). The OBD II standard is herein incorporated by reference in its entirety for all purposes.

Each protocol supports thousands of commands or Parameter Identifiers (PIDs). Each PID provides access to data with a wide range of values and meanings. The result is a massive amount of information available via the OBD II.

A common approach for accessing OBD II information is via the aforementioned scan tool. The scan tool may convert the OBD II messaging and signaling protocols into a communication format accessible through a computer. The computer contains the majority of the “intelligence” necessary to identify how to retrieve/set parameters as required by a particular application.

Unfortunately, it is typically cost prohibitive to contain all of the intelligence with the scan tool, mostly due to memory and/or processing requirements. This challenge is especially pronounced in applications requiring a stand-alone OBD II type module, in which case a computer is unavailable to off-load the memory and processing.

### SUMMARY

The present disclosure provides a system and associated method for reducing the memory and processing requirements for a vehicle monitoring system, and more particularly on a vehicle monitoring module using OBD II messaging and signaling protocols.

In one aspect, the reduction in memory and processing requirements may be accomplished by maintaining a local database disposed on the vehicle monitoring module. The local database may include a select “set” or “sets” of information available from a main database, such as vehicle specifics (e.g. Ford Explorer 2006), parameter specifics (e.g. Fuel Level), signaling protocol (e.g. VPW, CAN, and the like) or a combination (union or intersection) of two or more selections (i.e. parameters, vehicles, signaling protocol).

The overall vehicle monitoring system may include a computer having a main database, and the vehicle monitoring module. The vehicle monitoring module may include a first processor and a local memory including a local database. The computer may be configured to execute a software application configured to accept a criteria from at least one input; analyze the criteria to determine specific information required from the main database for retrieving a vehicle parameter; extract the specific information from the main database; and convey the specific information to the first processor. The first processor is configured to receive the specific information regarding the vehicle parameter taken from the main database and convey and store the specific information regarding the vehicle parameter to the local database. The first processor may also be configured to communicate with a vehicle computer network to read certain data from the vehicle computer network related to the vehicle parameter. Alternatively, the vehicle monitoring module may not need to communicate with the vehicle computer network if non-vehicle related information is needed, such as tracking information and security features.

Advantageously, the vehicle monitoring module may also have the ability to capture events based on user-defined thresholds, for example, speed over X mph; and may also have the ability to record and report data on events as well, for example, waking up to reports and the like.

The foregoing and other features and advantages of the invention will become more apparent from the following detailed description, which proceeds with reference to the accompanying figures.

### BRIEF DESCRIPTION OF THE DRAWINGS

The features, objects, and advantages of the invention will become more apparent from the detailed description set forth below when taken in conjunction with the drawings, wherein:

FIG. 1 is a high-level diagram of a vehicle monitoring system according to the present invention;

FIG. 2 is a simplified schematic illustration of a vehicle monitoring module in accordance with an embodiment of the present invention;

FIG. 3 is a block diagram of a specific implementation of a vehicle monitoring module in accordance with an embodiment of the present invention;

FIG. 4 is a simplified schematic diagram of a wireless gateway module; and

FIG. 5 is a simplified schematic diagram of a wireless gateway module in accordance with an embodiment of the present invention.

### DETAILED DESCRIPTION

The following description is exemplary in nature and is not intended to limit the scope, applicability, or configuration of the invention in any way. Various changes to the described embodiment may be made in the function and arrangement of the elements described herein without departing from the scope of the invention.

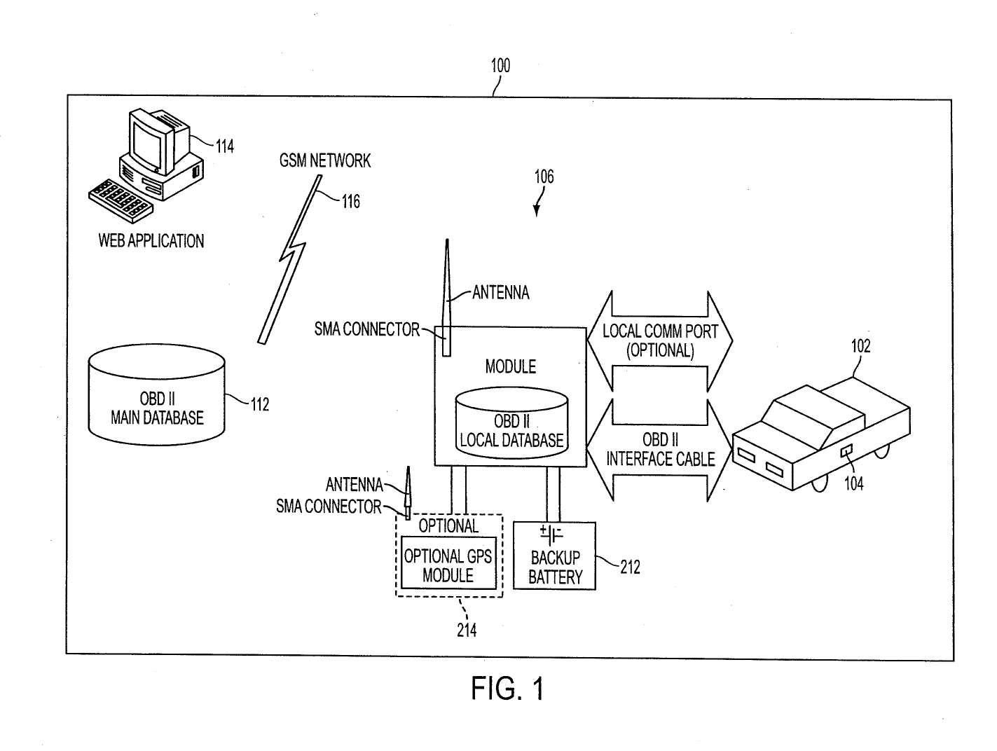

FIG. 1 is a high-level diagram of a monitoring system 100 according to one embodiment of the disclosure. In this embodiment, monitoring system 100 includes a vehicle 102 with vehicle computer network 104 residing thereon. In one embodiment, vehicle computer network 104 includes an OBD II interface module used to communicate directly with a vehicle monitoring module 106. Although the present disclosure describes monitoring system 100 for use with the current OBD II standard, it should be understood that any equivalent standard now known or later developed may be substituted without departing from the scope of the disclosure.

Monitoring system 100 further includes a main database 112 residing on a computer, a server or similar device (hereinafter “computer 114”). The intelligence on computer 114 includes, but is not limited to, determining vehicle type, signaling protocol, selecting PID, and other key communication parameters (timing, response code handling, and the like). As described in detail below, computer 114 may include a mechanism to select a desired subset of main database 112 and communicate the necessary subset of information to vehicle monitoring module 106, as necessary. Computer 114 may provide additional capabilities including providing security and convenience features to vehicle monitoring module 106. In one embodiment, computer 114 includes a host application which may be configured with cellular (GSM) based functionalities such that it can be queried to interface with vehicle monitoring module 106 via GSM network 116. Alternatively, system information may also be transmitted using various types of modems, such CDMA, RF, direct satellite and the like, over a variety of wireless networks and protocols such as, but not limited to, RF, GPRS, GSM, SMTP, WCTP, Satellite, Bluetooth and the like.

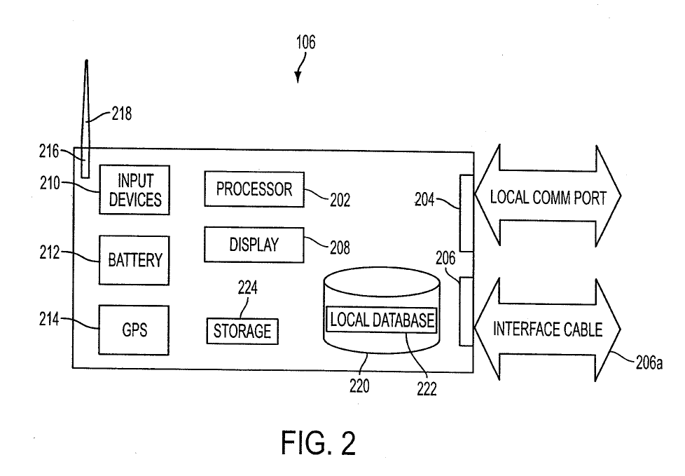

FIG. 2 is a schematic illustration of vehicle monitoring module 106 according to one embodiment of the disclosure. Vehicle monitoring module 106 includes a processor 202 in communication with a local communication port 204, a communication cable port 206, a display 208, one or more input devices 210, an optional battery backup system 212 and an optional GPS module 214. An SMA connector 216 may be included for connecting additional features, such as an antenna 218 for allowing communication with GSM network 116 (FIG. 1) or a similarly functioning network. Those of ordinary skill in the art will appreciate that vehicle monitoring module 106 may include any combination of these components as well as other conventional components.

In one embodiment, vehicle monitoring module 106 also includes a local memory 220 including a local database 222 residing thereon in accordance with an embodiment of the present invention. Local memory 220 may include, for example, cartridge memories (such as those containing EPROM, EEPROM, or Flash PROM memories), PC cards, stick memories and the like. In one embodiment, local database 222 may be generated by processes external to vehicle monitoring module 106. Local database 222 may take forms, including but not limited to, an actual database, a table, or integrated into a program space to define a firmware. As discussed below, the external processes may be implemented several ways depending on the nature of main database 112 (FIG. 1).

In one embodiment, when vehicle information is needed vehicle monitoring module 106 may be placed in communication via a connection link carried by a communication cable 206a with vehicle computer network 104, which may include a network of one or more ECM modules. Communication cable 206a typically has a connector affixed thereto that connects to a mating connector in communication with vehicle computer network 104.

Processor 202 may be one of virtually any number of processor systems and/or stand-alone processors, such as microprocessors, microcontrollers, and digital signal processors, and has associated therewith, either internally therein or externally in circuit communication therewith, associated RAM, ROM, EPROM, clocks, decoders, memory controllers, and/or interrupt controllers, and the like (all not shown) known to those in the art to be needed to implement a processor circuit.

Local communications port 204 and communication cable port 206 typically generate one or more communications protocols with which vehicle monitoring module 106 and vehicle computer network 104 communicate with one-another. The communication circuitry associated with communication ports 204 and 206 may be implemented either in hardware, or in software, or in a combination of hardware and software. Typical communications protocols generated by the communication circuitry of vehicle monitoring module 106 may include, but is not limited to, SAE J1850 (VPW), SAE J1850 (PWM), ISO 9141-2, and ISO 14230-4. The present invention is not intended to be limited to any specific protocol, or even to electrical communications protocols. Other present and future protocols, such as fiber optic and wireless communications protocols are also contemplated as being within the scope of the present invention.

Display 208 may be one or more of virtually any type of display, such as textual displays (such as n character by m line LCD or plasma displays, and the like), binary displays (such as LEDs, lamps, and the like), graphical displays (such as LCD displays that can display text and bar graphs and the like), or equivalents thereof.

Input device(s) 210 typically include one or more keys or a keyboard, but may be one or more of virtually any type of input device, such as touch screens, and the like.

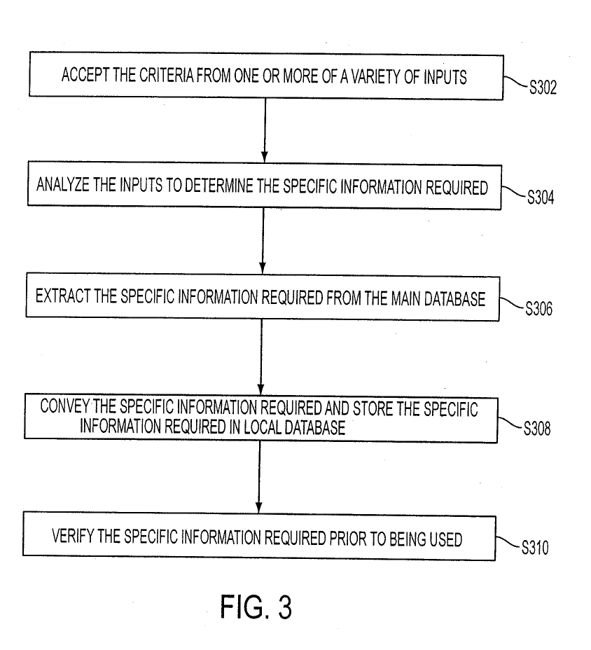

Referring now to FIGS. 1, 2 and 3, processor 202 of vehicle monitoring module 106 may execute a computer program stored in its RAM, ROM, Flash memory, and/or its EPROM (all not shown) and/or stored in any equivalent memory, using data stored in any one or more of those memories. In general, the computer program executed by processor 202 initializes vehicle monitoring module 106 and generates a user interface using, for example, input device(s) 210, through which a user causes vehicle monitoring module 106 to communicate with vehicle computer network 104 to read certain data from vehicle computer network 104, format such read data, and display the formatted data on display 208.

Vehicle monitoring module 106 may communicate remotely with computer 114 to access main database 112. As discussed, vehicle monitoring module 106 may be configured to include a subset of main database 112, depending on its expected function. According to one embodiment, vehicle monitoring module 106 minimizes the amount of information to be stored on local memory 220 to reduce the cover and overhead of information stored in local database 222 on vehicle monitoring module 106. In addition, vehicle monitoring module 106 may be updated with information, either directly or remotely, to provide flexibility and configurability of vehicle monitoring module 106.

In one embodiment, processor 202 uses data available from local database 222 to communicate to the one or more ECM modules on vehicle computer network 104. Optional alternate bus or wireless communication links may provide a means to transfer information. These links may also be used to update local database 222.

In one operational embodiment, a software application or the equivalent, running on computer 114 accepts a criteria from one or more of a variety of inputs, including but not limited to, a form, a file, or direct from a user, using drop-down menus, check boxes and the like (s302). The software application analyzes the inputs to determine the specific information required (s304) for retrieving and setting parameters. The specific information is then extracted from the main database 112 (s306) and conveyed to and stored in local database 222 (s308) on vehicle monitoring module 106 where it is used to perform a requested function.

For example, a user inputs a request specifying a query regarding a specific engine function. The software application accepts the criteria and analyzes it to determine all of the elements (OBD II parameters, codes and the like) required from main database 112 for completing the query. The software application then causes only these elements to be extracted from main database 112 and formats these elements into local database 222 on vehicle monitoring module 106. Vehicle monitoring module 106 then communicates the required codes and parameters with vehicle computer network 104 in order to receive the results of the engine function query. Since local database 222 of vehicle monitoring module 106 uses only the information supplied to it from main database 112 to diagnose vehicle 102, the size of memory 220 may be smaller and the processing requirements for processor 202 may be reduced.

Alternatively, the desired information may require a portion of the program space to be compiled. The changes to the program space may be tailored according to the criteria. This process may be accomplished through a variety of methods, including but not limited to making files, coding, objects, or defining statements, in which recompiling may or may not be required.

Processor 202 receives the data to be stored in local database 222 through one of many types of communication method. In one implementation, the communication method may be a wireless link. An alternate approach may include a wired communication link with a local (physical) connection to vehicle monitoring module 106. An initial set-up or initial data for local database 222 may be transferred through one or more communication methods, programmed into local database 222 prior to assembly, or set via an in-circuit programming tool.

As the specific information for local database 222 is received from main database 112, steps may be taken to verify the information (for example, via a checksum or similar error-checking method) prior to being used by vehicle monitoring module 106 (s310). The transferred information may reside in a temporary storage location 224 to await the validation prior to replacing the existing local database 222.

Vehicle monitoring module 106 may be used in numerous applications including, but not limited to, data loggers, event recorders, data reporting, ECM control, or a combination of these applications. While the applications may vary, the use of local database 222 may provide only the information necessary to retrieve and set the appropriate OBD II parameters.

In the exemplary case of a data logger, vehicle monitoring module 106 may be configured to record one or more parameters when a particular event occurs (i.e., timer expiration, data is inside/outside a specific range, on-command/demand, and the like).

Use of local database 222 may vary as a function of how local database 222 resides on vehicle monitoring module 106. For example, if local database 222 is table in nature, vehicle monitoring module 106 may perform a look-up to retrieve the information necessary to retrieve and set a parameter on a particular signaling protocol and/or vehicle. Alternatively, if local database 222 is program code and/or object based, the look-up may identify the appropriate routine/object to execute.

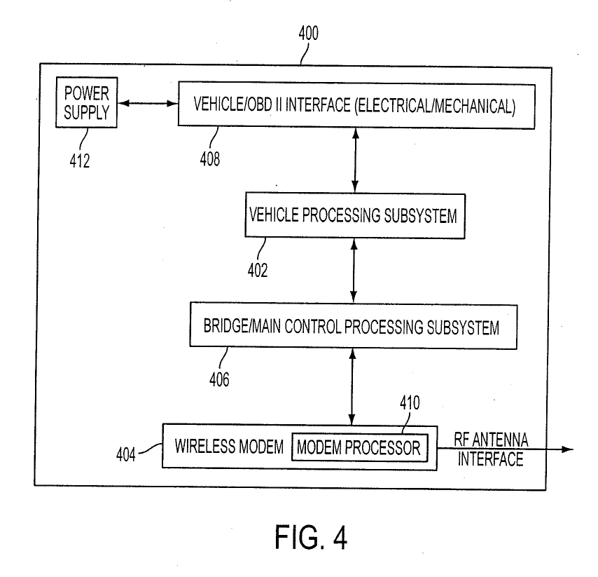

FIG. 4 is a simplified representation of a conventional gateway module 400. As described below, an improvement may be realized by eliminating one of the processing subsystems from gateway module 400, thus reducing the cost, size of the electronics, and power consumption of gateway module 400.

As shown in FIG. 4, gateway module 400 and similar devices typically use three separate processing subsystems to provide a mechanism of remotely retrieving and setting parameters. In such an implementation, vehicle processing subsystem 402 handles the control and communications signals necessary to retrieve and set parameter information via vehicle interface circuitry 408. Vehicle interface circuitry 408 also provides a source of power, which is available to power supply 412 of gateway module 400, which converts the power source accordingly. Wireless modem 404, which includes its own processing subsystem 410 (hereinafter “modem processor 410”), provides the communication channel to transfer data to and from a remote location via a network, such as GSM network 116 (FIG. 1) or an equivalent. The remaining processing subsystem is Bridge/Main Control Subsystem 406 (hereinafter “bridge processor 406”), which handles any protocol conversion between vehicle processing subsystem 402 and the wireless modem 404, message scheduling, communication parameter setup, wireless communication parameter setup, module status, and power management for gateway module 400.

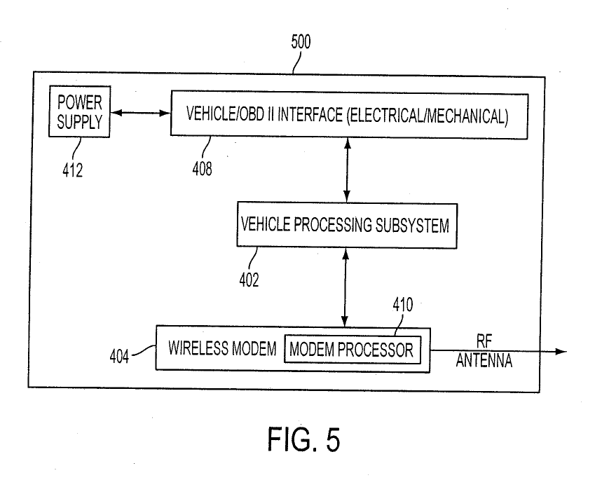

Some wireless modems 404 provide enough processing ability in modem processor 410 to perform tasks normally assigned to bridge processor 406. Accordingly, FIG. 5 is a schematic representation of an improved implementation of gateway module 400. Hereinafter the improved gateway module 400 is referred to as gateway module 500, which integrates the functionality of bridge processor 406 from previous generations into modem processor 410, thus eliminating components and circuitry associated specifically to bridge processor 406 (FIG. 4), to reduce the cost, size of electronics, and power consumption of gateway module 400. In an alternative embodiment, surplus processing capabilities available in vehicle processing subsystem 402 may be used to integrate all or portions of the processing capabilities of bridge processor 406. In another alternative embodiment, the processing functionalities of bridge processor 406 may also be assumed by a combination of both vehicle processing subsystem 402 and modem processor 410.

The invention has been disclosed in an illustrative manner. Accordingly, the terminology employed throughout should be read in an exemplary rather than a limiting manner. Although minor modifications of the invention will occur to those of ordinary skill in the art, it shall be understood that what is intended to be circumscribed within the scope of the patent warranted hereon are all such embodiments that reasonably fall within the scope of the advancement to the art hereby contributed, and that scope shall not be restricted, except in light of the appended claims and their equivalents.

What is claimed is:

1. A monitoring system comprising:
a main database; and
a module including a first processor and a local database, the first processor configured to receive a specific information regarding a vehicle parameter from the main database and convey the specific information regarding the vehicle parameter to the local database, the first processor configured to communicate with a vehicle computer network to read certain data from the vehicle computer network related to the vehicle parameter.

2. The system of claim 1, wherein the module further comprises a GPS module.

3. The system of claim 1, wherein the module further comprises a display and input devices.

4. The system of claim 1, wherein the first processor formats the certain data, and displays the formatted certain data on a display.

5. The system of claim 1, wherein the module further comprises a local memory in which the local database is maintained.

6. The system of claim 5, wherein the local memory further comprises one of EPROM, EEPROM, or Flash PROM memories, cartridge memories, PC cards, and stick memories.

7. The system of claim 1, wherein the local database further comprises a look-up table, wherein a look-up retrieves the specific information to retrieve and set a parameter on a particular signaling protocol.

8. The system of claim 1, wherein the local database further comprises instructions for identifying the appropriate routine or object to execute.

9. The system of claim 1, further comprising a computer configured to execute a software application configured to:
accept a criteria from at least one input;
analyze the criteria to determine the specific information required from the main database for retrieving the vehicle parameter;
extract the specific information from the main database; and
convey the specific information to the first processor.

10. The system of claim 9, wherein the computer communicates with the module over a variety of wireless networks using a variety of protocols.

11. A monitoring system comprising:
a computer including a main database; and
a module including a first processor and a local memory including a local database, the computer configured to execute instructions to:
accept a criteria from at least one input;
analyze the criteria to determine a specific information required from the main database for retrieving a vehicle parameter;
extract the specific information from the main database; and
convey the specific information to the first processor,
the first processor configured to receive the specific information regarding the vehicle parameter from the main database and convey the specific information regarding the vehicle parameter to the local database, the first processor configured to communicate with a vehicle computer network to read certain data from the vehicle computer network related to the vehicle parameter.

12. The system of claim 11, wherein the module further comprises a GPS module.

13. The system of claim 11, wherein the module further comprises a display and input devices.

14. The system of claim 11, wherein the first processor formats the certain data, and displays the formatted certain data on a display.

15. The system of claim 11, wherein the module further comprises a local memory upon which the local database is stored.

16. The system of claim 15, wherein the local memory comprises one of EPROM, EEPROM, or Flash PROM memories, cartridge memories, PC cards, and stick memories.

17. The system of claim 11, wherein the local database further comprises a look-up table, wherein a look-up retrieves the specific information to retrieve and sets a parameter on a particular signaling protocol.

18. The system of claim 11, wherein the local database further comprises instructions for identifying the appropriate routine or object to execute.

19. The system of claim 11, wherein the computer communicates with the module over a variety of wireless networks using a variety of protocols.

20. A monitoring method comprising:
accepting a criteria from at least one input;
analyzing the criteria to determine specific information required from a main database for retrieving a vehicle parameter;
extracting the specific information from the main database; and
conveying the specific information to a module including a first processor and a local database, the first processor configured to receive the specific information regarding the vehicle parameter taken from the main database and convey the specific information regarding the vehicle parameter to the local database, the first processor configured to communicate with a vehicle computer network to read certain data from the vehicle computer network related to the vehicle parameter.
